(19) United States
(12) Patent Application Publication
(10) Pub. No.: US 2005/0015405 A1
(43) Pub. Date: Jan. 20, 2005

(54) Multi-valued properties

(75) Inventors: Daniel Plastina, Sammamish, WA (US); Michael Novak, Redmond, WA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Microsoft Corporation

(21) Appl. No.: 10/623,010

(22) Filed: Jul. 18, 2003

(51) Int. Cl. G06F 17/00

(52) U.S. Cl. 707/104.1; 707/100

(57) ABSTRACT

A method and system for displaying metadata included in one or more media files. A media library stores one or more media files. A graphical user interface displays metadata of the one or more media files in the media library via a display. A media player application parses data contained in metadata fields of a media file to identify one or more properties of the media file. The user interface allows a user to view each identified property within a metadata field of the media files in a hierarchical format.

### TECHNICAL FIELD

The present invention relates to the field of processing digital media content. In particular, this invention relates to an improved method for displaying metadata within digital media files to enhance user experience.

### BACKGROUND OF THE INVENTION

Due to recent advances in technology, computer users are now able to enjoy many features that provide an improved user experience, such as playing various media and multimedia content on their personal or laptop computers. For example, most computers today are able to play compact discs (CDs) so users can listen to their favorite musical artists while working on their computers. Additionally, many computers are equipped with digital versatile disc (DVD) drives enabling users to watch movies.

As users become more familiar with advanced features on their computers, such as those mentioned above, their expectations of the various additional innovative features will undoubtedly continue to grow. For example, consider a media player software application that enables a user to play a CD on his or her computer. Typical applications allow the user to display track information associated with the CD in a media library by clicking on an appropriate user interface (UI). Such track information is often referred to as Metadata.

Metadata for digital media such as a music file is general information pertaining to the media file itself. For example, a music file may have the song title, song artist, and album title for the work as metadata tags. Frequently, users may want to display each media file that has a particular metadata property, such as an artist, in common. For example, the media library may include a song by the artist “Frank Sinatra,” and a duet by the artists “Frank Sinatra and Aretha Franklin.” In this case, the user would expect to be able to browse the media library and find a node named “Frank Sinatra.” In that node, the user would expect to see all the songs by “Frank Sinatra.” When selecting the “Frank Sinatra” artist node, the user would probably like to display both solo and duet songs. Traditionally, users would not be able to view songs by individual artist and duets.

Accordingly, this invention arose out of concerns for providing improved systems and methods for parsing out the multiple properties within metadata fields of a media file for displaying media content that provide an improved, rich, and robust user experience.

### SUMMARY OF THE INVENTION

The invention meets the above needs and overcomes one or more deficiencies in the prior art by providing improved user experience when displaying metadata associated with various media files. The invention provides a user interface that permits the user to efficiently display multi-valued fields of the media file. The invention parses out multi-valued fields of a media file to identify distinct properties that can be displayed to the user via the interface. Moreover, the user interface of the invention displays metadata in a hierarchical format that enhances the experience of the user when viewing metadata associated with a media file.

In accordance with one aspect of the invention, a method is provided for displaying metadata of a media file being stored in a memory. The media file includes a first metadata field that has first property data and a second metadata field that has second property data, and each property data defines a property of the media file, respectively. The method includes identifying a first property category from the first metadata field of the media file. The method further includes parsing the first property data included in the first metadata field to identify a first property and a second property defined by the first property data. The method further includes displaying the identified first property category, the identified first property, and the identified second property in hierarchically organized levels via a graphical user interface. The identified property category is displayed as a first level of the hierarchically organized levels, and the identified first property and the identified second property are displayed as a second level of the hierarchically organized levels.

In accordance with another aspect of the invention, a computer-readable medium having computer executable instructions for displaying metadata of a media file being stored in a memory. The media file includes a first metadata field that has first property data, and includes a second metadata field that has second property data, and each property data defines a property of the media file, respectively. Identifying instructions identify a first property category from the first metadata field of the media file. Parsing instructions parse the first property data included in the first metadata field to identify a first property and a second property defined by the first property data. Displaying instructions display the identified first property category, the identified first property, and the identified second property in hierarchically organized levels via a graphical user interface, wherein the identified property category is displayed as a first level of the hierarchically organized levels, and wherein the identified first property and the identified second property are displayed as a second level of the hierarchically organized levels.

In accordance with another aspect of the invention, a computer system includes a graphical user interface having a display and a user interface selection device, and provides a method for displaying metadata of a selected media file of on the display. The media file is selected by a user via the interface selection device from one or more media files being stored in a media library. The media file includes a first metadata field having first property data, and includes a second metadata field having second property data, each property data defining a property of the media file, respectively. The method includes identifying a first property category from the first metadata field of the media file. The method further includes parsing the first property data included in the first metadata field to identify a first property and a second property defined by the first property data. The method further includes displaying the identified first property category, the identified first property, and the identified second property in hierarchically organized levels via a graphical user interface, wherein the identified property category is displayed as a first level of the hierarchically organized levels, and wherein the identified first property and the identified second property are displayed as a second level of the hierarchically organized levels.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary computer system in which the present invention can be used.

FIG. 2 is an exemplary block diagram illustrating the components of a media file.

FIG. 3 is an exemplary block diagram illustrating components of a media player application according to one embodiment of the invention.

FIG. 4 is a screen shot of a graphical user interface provided by the media player application.

FIG. 5 is an exemplary user interface illustrating the hierarchy for displaying category data and property data according to one embodiment of the invention.

FIG. 6 is an exemplary flow chart illustrating a method of displaying metadata of a media file according to one embodiment of the invention.

FIG. 7 is a block diagram illustrating one example of a suitable computing system environment in which the invention may be implemented.

Corresponding reference characters indicate corresponding parts throughout the drawings.

### DETAILED DESCRIPTION OF THE INVENTION

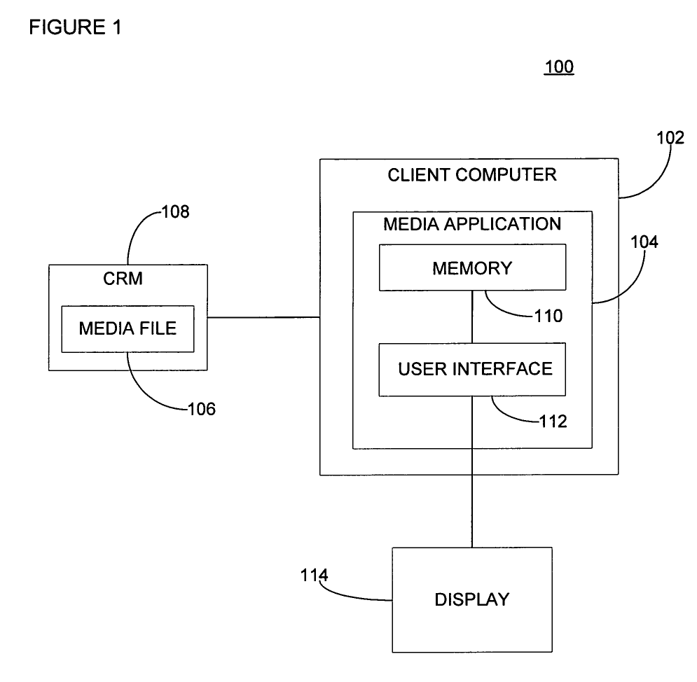

Referring now to the drawings, FIG. 1 illustrates an exemplary computer system 100 in which the present invention can be used. A system 100 includes a client computer 102 that executes a media player application 104. The media player application 104 can be any suitable rendering filter or program that is configured to play digital media so that a user can experience the content embodied on the media. For example, suitable media player applications 104 include a CD media player application and a DVD media player application. Executing the media player application 104, allows the user to access a digital media file 106 on a computer readable medium (CRM) 108 such as a compact disc, a network server, or any other suitable computer storage media, and enables the user or, particularly, enables media player application 104 to access, retrieve, store, and display for the user, so-called metadata. Those skilled in the art are familiar with metadata, which is simply information about data. In the context of the present invention, metadata involves information related to specific content of digital media file 106 being played via the media player application 104. Basic metadata may include one or more of album title, artist, performer, genre, description of content, and the like. Extended metadata includes cover art, performer biographies, reviews, related performers, where to buy similar items, upcoming concerts, ticket sales, URLs to other related experiences including purchase opportunities, and the like. The media player application 104 includes a memory 110 for storing digital media files 106, and a graphical user interface 112 for displaying media files 106 and organized metadata to the user on a display 114.

In the examples herein, the media content of digital media file 106 refers to a single song track or a collection of tracks such as found on an audio CD. It is to be appreciated and understood that the media content can be embodied on any suitable media, including digital files downloaded to the client computer's memory, and that the specific examples described herein are given to further understanding of the inventive principles. The media content can include, without limitation, specially encoded media content in the form of, for example, an encoded media file 106 such as media content encoded in Microsoft® Windows Media™ format using the Microsoft® Windows Media™ Player program, or encoded in a Moving Picture Experts Group audio layer-3 (MP3) format.

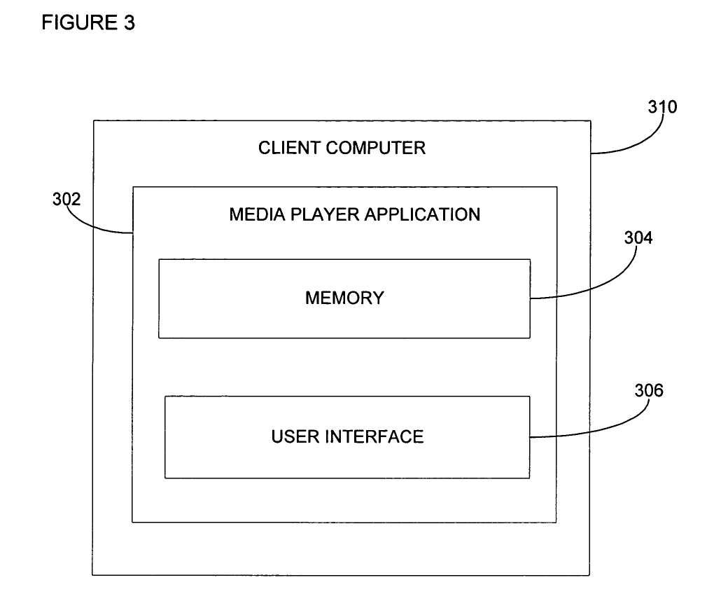

The resultant system 100 allows improved management of metadata to enhance user experience when displaying a media file 106. More specifically, the present invention enables viewing of individual properties within multi-valued metadata fields. The invention further allows a user to view the metadata of a media file 106 in hierarchical format that provides the user the ability to quickly and efficiently identify various metadata properties associated with one or more metadata categories of a media file 106. As described in more detail below in reference to FIG. 3, a multi-valued field, or a multiple-property field, refers a metadata field of a media file 106 that includes multiple properties. A metadata property defines a specific property within a category of metadata such as genre, album title, artist, or the like. For instance, a specific metadata property for genre may be rock, rap, or country. By parsing multi-valued metadata fields of the media file 106 to identify individual properties, the invention allows a user to view a media file that include multiple properties in a metadata field when the user is only interested in media files 106 that includes a specific metadata property. Thus, system 100 provides improved management of metadata by permitting a user to view and interact with individual properties within multi-valued metadata fields of a media file 106.

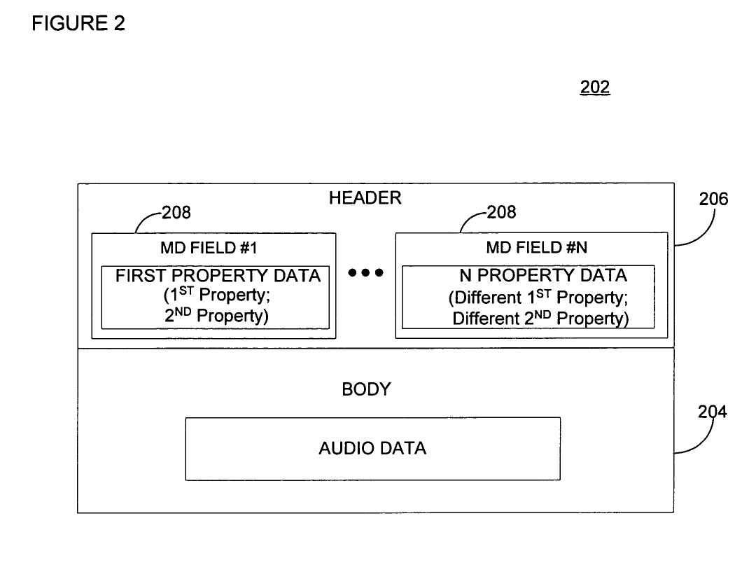

Referring next to FIG. 2, the components of an exemplary media file 202 (e.g., media file 106) are shown. In this case, the media file 202 represents a song track such as described above in reference to FIG. 1. The media file 202 includes a body section 204 and a header section 206. The body 206 stores digital audio information that is used by the media player application 104 to play the particular music track. Although the body 204 is described herein as storing digital audio information, it is contemplated that the body 204 of a media file 202 may include digital video information. The header 206 stores digital information, which is used by the media player application 104 to display information (i.e., metadata) about the particular music track. For example, the header 206 may include track information such as the song title, song artist, and album title for the work as stored metadata. The header 206 includes a plurality of metadata fields 208 that each store property data for a particular category of metadata. Property data defines one or more particular properties that the media file 202 has within the particular metadata category. For instance, metadata field #1 may store information related to a genre category, and may have a property that indicates the genre is “Rock,” or may have multiple properties indicating the genre is both “Rock” and “Ballad.” In contrast, metadata field #N may store information related to an artist category, and may have a property that indicates Frank Sinatra is the artist for the media file, or may have multiple properties indicating that both Frank Sinatra and Aretha Franklin are artist for the particular media file.

Referring next to FIG. 3, an exemplary block diagram illustrates basic components of a media player application 302 (e.g., media player application 104) having computer executable instructions for storing, displaying, and editing media files (e.g., media files) according to one embodiment of the invention. The media player application 302 includes a media library 304 (e.g., memory 110) for storing media files 304, and a user interface (UI) 306 for displaying and allowing a user to interact with media files 304. In this embodiment, a client computer 310 (e.g., computer 102) stores and executes the media player application 302. Upon execution, the media player application 302 identifies all media files on the computer 310 it can process, and transfers the identified files to the media library 304. If the media player application 302 is running when the user copies audio files from a CD, the Internet, or other source, the audio files are automatically directed to the media library 304 for storage. The media player application of the invention includes computer executable instructions for parsing contents of multi-valued (i.e., multiple property) metadata fields to identify individual properties. When multiple properties are stored in a metadata field, the media player application 302 analyzes data stored within the metadata field to identify a property delimiter. The property delimiter is a character or symbol (e.g., ; $, ≠, or _) used by the media player application to differentiate between multiple properties within a metadata field. The UI 306 displays the data in the media library 304, and allows the user to view and/or edit the stored data.

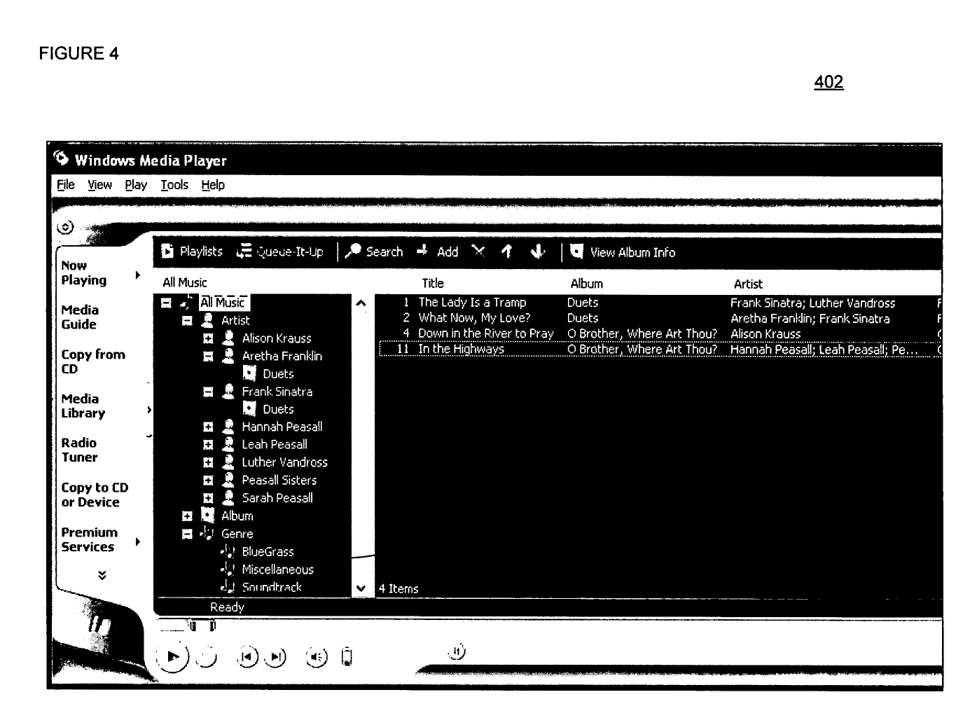

Referring now to FIG. 4, a screen shot illustrates an exemplary user interface 402 (e.g., UI 306) for displaying and manipulating media files (e.g., tracks) stored within the media library of Windows Media® Player offered by Microsoft, Inc. The user interface 402 displays a list of media files in a media file data section 406, and displays category nodes 408 and property nodes 410 in an indexing section 412. The user interacts with data being displayed via the user interface 402 by using commonly known navigation techniques. For instance, the user can use a mouse linked to the computer to navigate through the user interface 402 and to select media files 304, category nodes 408 and or property nodes 410. Each category node 408 corresponds to a particular property category such as artist, album title, or genre. Each property node 410 defines a specific metadata property within a property category. For example, the property node labeled “Frank Sinatra” defines a specific artist within the artist category. The media file data section 406 is responsive to the user selection in the indexing section 412 to display property data included in each of the one or more media files stored in the media library. For instance, the second media file in the list of media files displayed in the media file data section 406 includes “What Now, My Love?” as title property data, “Duets” as album property data, and “Frank Sinatra; Aretha Franklin” as artist property data. Although the invention is described herein in reference to displaying category nodes for artist, album title, and genre property categories, and property nodes for artist, album title, and genre properties, it is to be understood that the invention can be used to display category nodes and property nodes that correspond to a variety of property categories or properties, respectively.

Existing media player interfaces typically display a single property node that corresponds to the entire contents of a particular metadata field. However, the user interface 402 of the invention displays a property node 410 for each property in a metadata field of the media file. As described above in reference to FIG. 3, the media player application parses contents of multi-valued (i.e., multiple property) metadata fields to identify individual properties, and uses the property delimiter to differentiate between multiple properties within a metadata field. For example, referring again to the first media file in the list of media files shown in the media file data section 406, the media player application parses contents of the metadata field containing artist data to identify a property delimiter. In this case, the property delimiter “;” differentiates Frank Sinatra from Aretha Franklin, and the media player application displays a property node 410 labeled Frank Sinatra and a property node 410 labeled Aretha Franklin via the user interface 402. As a result, a user can select the property node 410 labeled “Frank Sinatra,” and display all media files from the media library that have the artist metadata property “Frank Sinatra.” As shown in FIG. 4, when the property nodes labeled Frank Sinatra and Aretha Franklin are selected, as indicated by the “-” symbol within the property node, the user interface 402 displays different property nodes 414 (sub-nodes) labeled “Duets” to identify albums by artist Frank Sinatra and Aretha Franklin, respectively. Notable, if the property node labeled Luther Vandross was selected, the user interface 402 would also display a different property node 414 (sub-nodes) labeled “Duets.” As a result, a user can view, not just the tracks by individual artist in the media file data section 406, but can also can also view albums by a particular artist via the album property node 414.

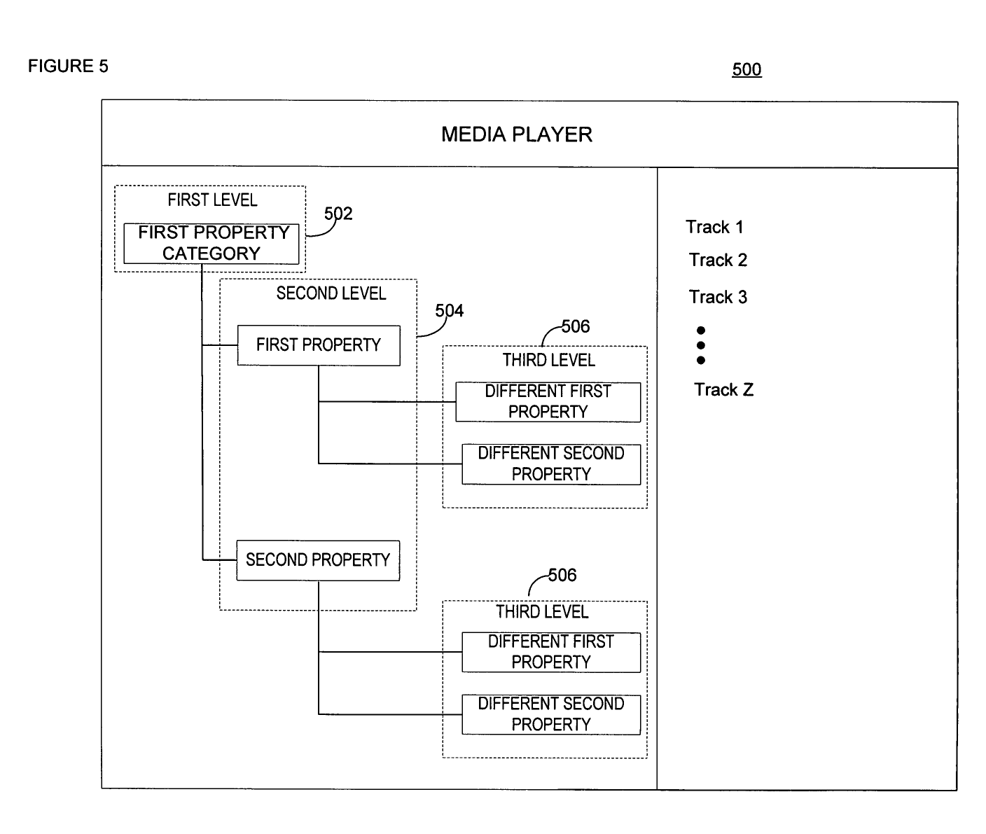

Referring now to FIG. 5, an exemplary user interface 500 illustrates the hierarchy for displaying category data and property data in the indexing section. In this case, the top level is a property category level that represents a category node. The category nodes correspond to a particular category of metadata such as Artist, Album, or Genre. Within the property category level, there is a first property level corresponding to one or more properties within the property category. Each of the one or more properties corresponds to a property node. Within the first property level, there is a second property level identifying one or more different properties within a different property category. Each of the one or more different properties corresponds to a different property node or sub-node. For example, referring briefly again to FIG. 4, the node labeled Artist corresponds to a property category level; the nodes labeled “Alison Krauss,” “Aretha Franklin,” “Frank Sinatra,” “Hannah Peasall,” “Leah Peasall,” “Luther Vandross,” “Peasall Sisters,” and “Sarah Peasall” each correspond to the first property level, and the property nodes labeled “Duets” correspond to a second property level.

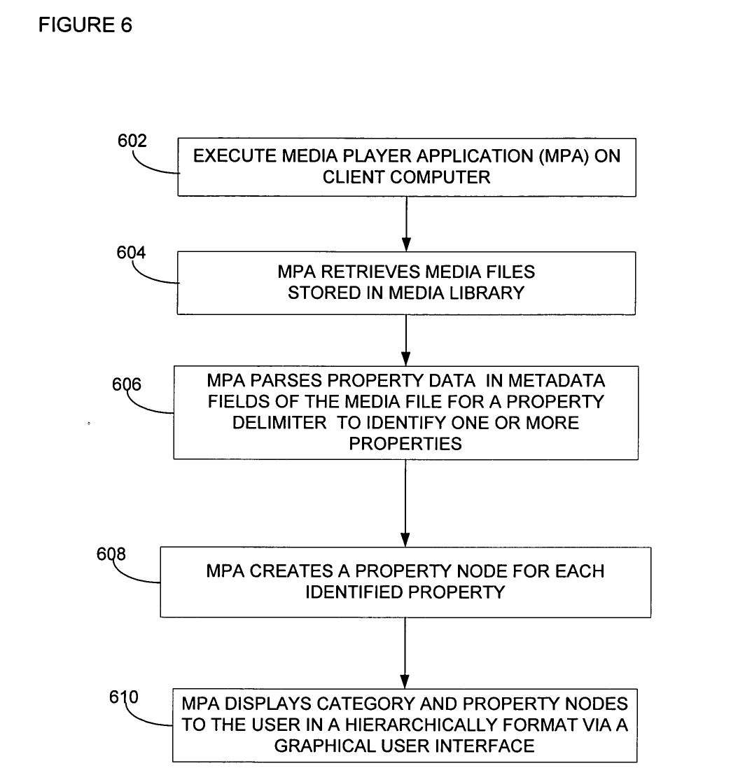

Referring now to FIG. 6, an exemplary flow chart illustrates a method of displaying metadata of a media file according to one embodiment of the invention. A user executes the media player application on the client computer at 602. At 604, the media player application retrieves media files stored in the media library. At 606, the MPA parses property data within each metadata field of the media file for property delimiters to identify one or more properties. The MPA creates a property node for each property in each metadata field of each media file at 608. At 610, the MPA displays category nodes and property node in a hierarchical format via a graphical user interface such as described above in reference to FIG. 4 and FIG. 5.

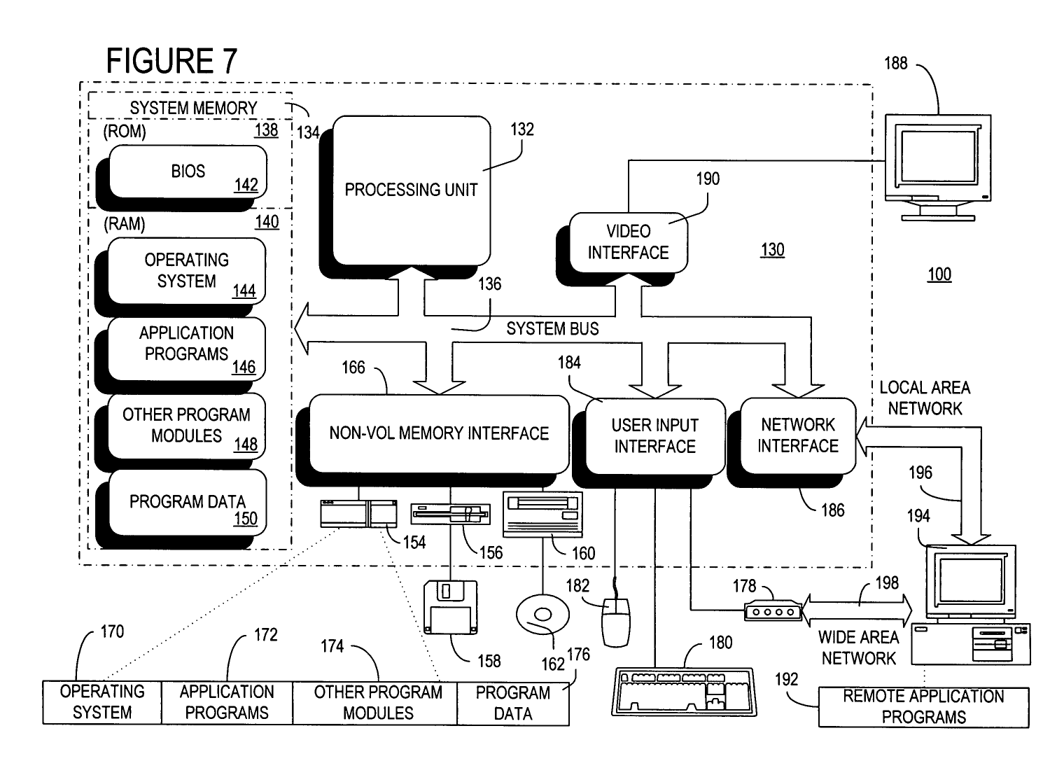

FIG. 7 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that can be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 7 illustrates operating system 144, application programs 146, other program modules 148, and program data 150.

The computer 130 may also include other removable/non-removable, volatile/nonvolatile computer storage media. For example, FIG. 7 illustrates a hard disk drive 154 that reads from or writes to non-removable, nonvolatile magnetic media. FIG. 7 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 7, provide storage of computer readable instructions, data structures, program modules and other data for the computer 130. In FIG. 7, for example, hard disk drive 154 is illustrated as storing operating system 170, application programs 172, other program modules 174, and program data 176. Note that these components can either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 7 include a local area network (LAN) 196 and a wide area network (WAN) 198, but may also include other networks. LAN 136 and/or WAN 138 can be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 7 illustrates remote application programs 192 as residing on the memory device. It will be appreciated that the network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

In operation, computer 130 executes computer-executable instructions such as those illustrated in FIG. 6 to display metadata of a media file being stored in a memory.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

1. A method for displaying metadata of a media file being stored in a memory, said media file having a first metadata field including first property data, and having a second metadata field including second property data, each property data defining a property of the media file, respectively, comprising:
identifying a first property category from the first metadata field of the media file;
parsing the first property data included in the first metadata field to identify a first property and a second property defined by the first property data; and
displaying the identified first property category, the identified first property, and the identified second property in hierarchically organized levels via a graphical user interface, wherein the identified property category is displayed as a first level of the hierarchically organized levels, and wherein the identified first property and the identified second property are displayed as a second level of the hierarchically organized levels.

2. The method of claim 1, wherein the identified first property category identifies a genre category, album category, or an artist category.

3. The method of claim 1, wherein the identified first property and the identified second property each identify a genre property, an album property, or an artist property.

4. The method of claim 1, wherein parsing property data includes parsing property data to identify a property delimiter, and wherein the property delimiter separates the identified first property from the identified second property.

5. The method of claim 1 further including modifying property data included in the metadata field of the media file to modify the identified property category, the first identified property, or the second identified property being displayed in the hierarchically organized levels.

6. The method of claim 1 further including:
identifying a second property category from the second metadata field of the media file; wherein the second property category is different from the identified first property category; and
parsing the second property data included in the second metadata field to identify a different first property different than the first property and a different second property different than the second property, and wherein displaying includes displaying the different first property or the different second property in a third level of the hierarchically organized levels.

7. The method of claim 1, wherein the identified second property category identifies a genre category, album category, or an artist category.

8. A computer-readable medium having computer executable instructions for displaying metadata of a media file being stored in a memory, said media file having a first metadata field including first property data, and having a second metadata field including second property data, each property data defining a property of the media file, respectively, comprising:
identifying instructions for identifying a first property category from the first metadata field of the media file;
parsing instructions for parsing the first property data included in the first metadata field to identify a first property and a second property defined by the first property data; and
displaying instructions for displaying the identified first property category, the identified first property, and the identified second property in hierarchically organized levels via a graphical user interface, wherein the identified property category is displayed as a first level of the hierarchically organized levels, and wherein the identified first property and the identified second property are displayed as a second level of the hierarchically organized levels.

9. The computer-readable medium of claim 8, wherein the identified first property category identifies a genre category, album category, or an artist category.

10. The computer-readable medium of claim 8, wherein the identified first property and the identified second property each identify a genre property, an album property, or an artist property.

11. The computer-readable medium of claim 8, wherein parsing instructions parse property data to identify a property delimiter, and wherein the property delimiter separates the identified first property from the identified second property.

12 The computer-readable medium of claim 8, wherein the identifying instructions further identify a second property category from the second metadata field of the media file; wherein the second property category is different from the identified first property category; and wherein parsing instructions further parse the second property data included in the second metadata field to identify a different first property different than the first property and a different second property different than the second property, and wherein displaying includes displaying the different first property or the different second property in a third level of the hierarchically organized levels.

13. The computer readable medium of claim 12, wherein the identified second property category identifies a genre category, album category, or an artist category.

14. In a computer system having a graphical user interface including a display and a user interface selection device, a method of displaying metadata of a selected media file on the display, wherein the media file is selected by a user via the interface selection device from one or more media files being stored in a media library, said media file having a first metadata field including first property data, and having a second metadata field including second property data, each property data defining a property of the media file, respectively, comprising
identifying a first property category from the first metadata field of the media file;
parsing the first property data included in the first metadata field to identify a first property and a second property defined by the first property data; and
displaying the identified first property category, the identified first property, and the identified second property in hierarchically organized levels via a graphical user interface, wherein the identified property category is displayed as a first level of the hierarchically organized levels, and wherein the identified first property and the identified second property are displayed as a second level of the hierarchically organized levels.

15. The method of claim 14, wherein parsing property data includes parsing property data to identify a property delimiter, and wherein the property delimiter separates the identified first property from the identified second property.

16. The method of claim 14 further including:
identifying a second property category from the second metadata field of the media file; wherein the second property category is different from the identified first property category; and
parsing the second property data included in the second metadata field to identify a different first property different than the first property and a different second property different than the second property, and wherein displaying includes displaying the different first property or the different second property in a third level of the hierarchically organized levels.
